(19) United States
(12) Patent Application Publication
(10) Pub. No.: US 2021/0395451 A1
(43) Pub. Date: Dec. 23, 2021

(54) POLYMERIC MATERIALS

(71) Applicant: VICTREX MANUFACTURING LIMITED, Thornton-Cleveleys, Lancashire (GB)

(72) Inventor: Geoff SMALL, Thornton-Cleveleys, Lancashire (GB)

(21) Appl. No.: 17/290,122

(22) PCT Filed: Oct. 29, 2019
(86) PCT No.: PCT/GB2019/053046

§ 371 Date: Apr. 29, 2021

(30) Foreign Application Priority Data
Oct. 30, 2018 (GB) 1817700.6
Nov. 23, 2018 (GB) 1819074.4

(51) Int. Cl. C08G 65/40; C08L 27/18

(52) U.S. Cl. CPC C08G 65/4012; C08L 2203/30; C08G 2650/40; C08L 27/18

(57) ABSTRACT

There is disclosed a composition, suitable for use in dynamic applications at low temperature, the composition comprising a first polymeric material (A) having a repeat unit of formula

—O-Ph-O-Ph-CO-Ph- I

wherein Ph represents a phenylene moiety; and
a second polymeric material (B) having a repeat unit of formula

(F2C—CF2)— II

and further comprising a pigment;
wherein said composition has a melt viscosity of at least 0.50 kNsm-2. There is also disclosed an assembly or apparatus, a use and a polymeric micropellet.

This invention relates to polymeric materials suitable for use in dynamic conditions at low temperatures such as components for seals, and particularly, although not exclusively, the invention relates to compositions of polymeric materials for use in dynamic conditions at low temperatures, for example cryogenic applications, such as valve components in liquefied natural gas (LNG) applications or in the oil and gas industry in general. The invention also relates to compositions for use in polar regions.

LNG is a mixture of hydrocarbons, predominantly methane, but with varying levels of ethane, propane, butane and other naturally occurring gases found in natural gas. LNG normally has a boiling temperature between −166° C. and −57° C. at atmospheric pressure.

According to EN/ISO 16903, many common materials of construction fail in a brittle manner when they are exposed to these very low temperatures and recommends that materials used in contact with LNG should be proven resistant to brittle fracture.

Various steel and non-ferrous alloys have been developed over the years to meet the challenges of property retention in such extremes of temperature.

As an alternative to metals, polymers may be used in low temperature applications. There are several basic requirements for polymers to function well at very low temperatures—processability; and appropriate mechanical properties at both room temperature and low temperature.

In the context of polymers, the main problem with use at very low temperatures is the very low mobility of polymer chains and hence low levels of ductility. This may manifest itself when a part made from a polymeric material (e.g. a valve seat) is subjected to an increasing load. When the incidental load reaches a critical level, a crack may propagate rapidly in the part, even at relatively low energy, leading to failure of the part. Additionally, any surface defects or damage caused during use or manufacture of a polymeric part will act as a stress concentrator which could also lead to rapid and brittle failure in parts having low levels of ductility at the temperature of use. However, polymeric materials developed specifically for low temperature applications may not be particularly well suited to higher temperature applications and therefore the range of operating temperatures for certain polymeric materials may be reduced.

Commonly used polymers for low temperature applications include PTFE, PCTFE, FEP, polyethylene, polycarbonate, polyimides and various elastomers which have been specially formulated to retain ductility at very low temperatures. However, whilst such polymers may be suitable for some low temperature uses, for other uses, polymers are required which have improved mechanical, abrasion and erosion resistance properties, whilst having excellent chemical resistance properties.

Polyaryletherketones such as polyetheretherketone (PEEK) and polyetherketone (PEK) are well known high performance thermoplastic polymers which have excellent mechanical and chemical resistance properties, in general. However, it has been found by Applicant that some polyaryletherketones are less suited to use in dynamic applications in very low temperature applications compared to others. Furthermore, it has been found that certain PAEK polymers can suffer from sticktion, where it becomes harder to turn a ball in a valve seat due to the interaction with the surface of the ball in the valve seat.

It is an object of the present invention to address the above-described problems.

It is an object of the present invention to provide a polymeric material which may be advantageously used in dynamic applications at low temperature, for example, in cryogenic applications while also providing excellent properties at high temperatures in a range from around −196° C. to around 140° C.

According to a first aspect of the invention, there is provided a composition, suitable for use in dynamic applications at low temperature, the composition comprising a first polymeric material (A) having a repeat unit of formula

—O-Ph-O-Ph-CO-Ph- I
wherein Ph represents a phenylene moiety; and
a second polymeric material (B) having a repeat unit of formula

—(F₂C—CF₂)— II
and further comprising a pigment;
wherein said composition has a melt viscosity of at least 0.50 kNsm⁻².

Preferably, the composition includes at least 10 wt % polymeric material (B), more preferably, at least 15 wt % polymeric material (B), more preferably 20 wt % polymeric material (B). Preferably, the composition comprises at most 30% wt % polymeric material (B), more preferably, at most 25 wt % polymeric material (B).

Preferably, the composition includes at least 0.01 wt % pigment, more preferably, at least 0.1 wt % pigment, more preferably at least 0.5 wt % pigment. Preferably, the composition comprises at most 1 wt % pigment, more preferably, at most 0.8 wt % pigment.

In some embodiments, the sum of the wt % of the first polymeric material (A), the second polymeric material (B), and the wt % pigment preferably represents at least 90 wt % more preferably at least 95 wt %, especially at least 99 wt % or said composition. Thus said composition may consist essentially of polymeric material (A), polymeric material (B) and a pigment.

In some embodiments, the composition includes a wear resistant additive, such as mineral nitrides or graphite. Preferably, the composition includes at most 3 wt % wear resistant additive, more preferably, at most 2 wt % wear resistant additive.

Melt viscosity (MV) of said composition may be assessed, unless otherwise stated herein, as described in Test 1 hereinafter.

Said composition suitably has a MV of at least 0.55 kNsm⁻², preferably of at least 0.60 kNsm⁻², more preferably at least 0.62 kNsm⁻². The MV may be less than 1.0 kNsm⁻². Preferably, MV is in the range 0.55 to 0.75 kNsm⁻², for example in the range 0.60 to 0.70 kNsm⁻².

According to a further aspect of the invention, there is provided an assembly or apparatus suitable for use in relation to an assembly, wherein said assembly is subjected to a temperature of less than −50° C. in use, wherein said assembly or apparatus includes a component which comprises composition comprising a first polymeric material (A) having a repeat unit of formula

—O-Ph-O-Ph-CO-Ph- I
wherein Ph represents a phenylene moiety; and
a second polymeric material (B) having a repeat unit of formula

—(F₂C—CF₂)— II
and further comprising a pigment;
wherein said composition has a melt viscosity of at least 0.50 kNsm⁻².

Said assembly or apparatus may be subjected to a temperature of less than −75° C. or less than −100° C. or less than −120° C. or less than −140° C. in use. Advantageously, the component may have suitable properties at even lower temperatures. Thus, said assembly or apparatus may be subjected to a temperature of less than −150° C. or even less than −165° C.

Said component may be subjected to a temperature of less than −50° C. in use. Said component may be subjected to a temperature of less than −75° C. or less than −100° C. or less than −120° C. or less than −140° C. in use. Said component may be subjected to a temperature of less than −150° C. or even less than −165° C.

Said assembly may be positioned in a very low temperature environment (or in an environment which may reach a very low temperature), for example in an environment wherein the temperature is at less than −75° C., less than −100° C., less than −120° C., less than −150° C. or even less than −165° C. Said assembly may be in a polar region or underground. Said assembly may be an oil and/or gas installation. Said assembly may be associated with liquid natural gas (LNG), for example LNG handling, transport or storage devices. Said assembly may be a LNG storage tank and/or a part associated therewith. Said component may be part of the storage tank and/or a part associated therewith. In another example, said assembly may be subject to a range of temperatures wherein the temperature is at less than −75° C., less than −100° C., less than −120° C., less than −150° C. or even less than −165° C., but also wherein the temperature is up to 100° C.

Said component may be selected from the group comprising a seal, a valve, a part of a valve such as a valve seat, a gasket, a bearing, a part of a bearing, a housing, a ring, a pipe, a part of a pipe, a pipe liner, a connector, insulation, for example for wire or cable, and a bush.

Apparatus for use in relation to said assembly may comprise apparatus which is temporarily or intermittently used in relation to said assembly. For example, such apparatus may be introduced into (or used with) an oil or gas installation in order to carry out a task on or in relation to the oil or gas installation.

In a preferred embodiment, the composition includes at least 10 wt % polymeric material (B), more preferably, at least 15 wt % polymeric material (B), more preferably 20 wt % polymeric material (B). Preferably, the composition comprises at most 30% wt % polymeric material (B), more preferably, at most 25 wt % polymeric material (B).

Preferably, the composition includes at least 0.01 wt % pigment, more preferably, at least 0.1 wt % pigment, more preferably at least 0.5 wt % pigment. Preferably, the composition comprises at most 1% wt % pigment, more preferably, at most 0.8 wt % pigment.

In some embodiments, the sum of the wt % of the first polymeric material (A), the second polymeric material (B), and the wt % pigment preferably represents at least 90 wt % more preferably at least 95 wt %, especially at least 99 wt % or said composition. Thus said composition may consist essentially of polymeric material (A), polymeric material (B) and a pigment.

In some embodiments, the composition includes a wear resistant additive, such as mineral nitrides or graphite. Preferably, the composition includes at most 3 wt % wear resistant additive, more preferably, at most 2 wt % wear resistant additive.

In a preferred embodiment, at least 95%, preferably at least 99%, of the number of phenylene moieties (Ph) in polymeric material (A) have 1,4-linkages to moieties to which they are bonded. It is especially preferred that each phenylene moiety in polymeric material (A) has 1,4-linkages to moieties to which it is bonded.

Preferably, the phenylene moieties in repeat unit of formula I are unsubstituted.

Said polymeric material (A) may include at least 68 mol %, preferably at least 71 mol %, of repeat units of formula I.

Said repeat unit of formula I suitably has the structure

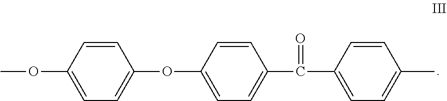

In a first preferred embodiment, said polymeric material (A) includes at least 80 mol %, preferably at least 90 mol %, more preferably at least 95 mol %, especially at least 99 mol % of repeat units of formula I, especially those of formula II. Thus, in this embodiment, said polymeric material (A) is preferably a homopolymer, which is preferably polyetheretherketone (PEEK).

In a second embodiment, said polymeric material (A) may have a repeat unit of formula I as described and a repeat unit of formula

—O-Ph-Ph-O-Ph-CO-Ph- IV
wherein Ph represents a phenylene moiety.

A preferred repeat unit of formula IV has the structure

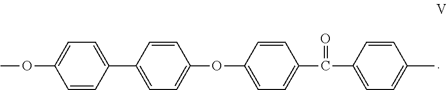

In said second embodiment, said polymeric material (A) may include at least 68 mol %, preferably at least 71 mol %, of repeat units of formula III. Particular advantageous polymers may include at least 72 mol %, or, especially, at least 74 mol % of repeat units of formula III. Said polymeric material (A) may include less than 90 mol %, suitably 82 mol % or less of repeat units of formula III. Said polymeric material (A) may include 68 to 82 mol %, preferably 70 to 80 mol %, more preferably 72 to 77 mol % of repeat units of formula III.

In said second embodiment, said polymeric material (A) may include at least 10 mol %, preferably at least 18 mol %, of repeat units of formula V. Said polymeric material (A) may include less than 32 mol %, preferably less than 29 mol % of repeat units of formula V. A particularly advantageous polymeric material (A) of the second embodiment may include 28 mol % or less; or 26 mol % or less of repeat units of formula V. Said polymeric material (A) may include 18 to 32 mol %, preferably 20 to 30 mol %, more preferably 23 to 28 mol % of units of formula V.

The sum of the mol % of units of formula III and V in said polymeric material (A) of the second embodiment is suitably at least 95 mol %, is preferably at least 98 mol %, is more preferably at least 99 mol % and, especially, is about 100 mol %.

In said second embodiment, the ratio defined as the mol % of units of formula III divided by the mol % of units of formula IV may be in the range 1.8 to 5.6, is suitably in the range 2.3 to 4 and is preferably in the range 2.6 to 3.3.

Melt viscosity (MV) of said composition may be assessed, unless otherwise stated herein, as described in Test 1 hereinafter.

Said composition suitably has a MV of at least 0.55 kNsm⁻², preferably of at least 0.60 kNsm⁻², more preferably at least 0.62 kNsm⁻². The MV may be less than 1.0 kNsm⁻². Preferably, MV is in the range 0.55 to 0.75 kNsm⁻², for example in the range 0.60 to 0.70 kNsm⁻².

Said component may include at least 40 wt %, suitably at least 50 wt %, preferably at least 80 wt %, more preferably at least 95 wt %, especially at least 98 wt % of said composition. Said component preferably consists essentially of said composition.

Said component which includes said composition may include at least 1 g, at least 5 g, at least 100 g or at least 500 g of said composition.

The invention of the first aspect preferably relates to an assembly as described (in preference to a said apparatus as described).

Said polymeric material (A) may be manufactured by aromatic nucleophilic substitution, wherein said aromatic nucleophilic substitution comprises reacting a nucleophile with a 4,4′-difluorobenzophenone monomer, and wherein said 4,4′-difluorobenzophenone monomer has a purity of at least 99.7% w/w by difference, preferably at least 99.8% w/w by difference, more preferably at least 99.85% w/w by difference, even more preferably at least 99.9% w/w by difference as measured using HPLC-UV analysis as set out in Test 3 herein.

According to a further aspect of the invention, there is provided a method of providing a component in a position (A) in which it is subjected to a temperature of less than −50° C., said method comprising:

(i) selecting a component, an assembly comprising said component or an apparatus comprising said component, wherein said component comprises a composition comprising a first polymeric material (A) having a repeat unit of formula

—O-Ph-O-Ph-CO-Ph- I

wherein Ph represents a phenylene moiety; and

a second polymeric material (B) having a repeat unit of formula

—(FC—CF)— II

and further comprising a pigment;

wherein said composition has a melt viscosity of at least 0.50 kNsm⁻²; and

(ii) moving said component, assembly or apparatus to position (A).

Position (A) may be such that the component is subjected to a temperature of less than −75° C., less than −100° C., less than −120° C., less than −150° C. or even less than −165° C.

The temperature at position (A) may be less than −50° C., less than −75° C., less than −100° C., less than −120° C., less than −150° C. or even less than −165° C.

Said position (A) may be in or adjacent a region which contains natural gas, for example liquid natural gas (LNG). Said position (A) may be in a polar region.

Said component, said assembly, said apparatus and said composition may be as described according to the first aspect.

According to a further aspect of the invention, there is provided the use of a composition for making a component for use in an environment in which the temperature is less than −50° C. or in which the temperature may fall to less than −50° C., for example during the presence in said environment of said component, wherein said composition comprises a first polymeric material (A) having a repeat unit of formula

—O-Ph-O-Ph-CO-Ph- I
wherein Ph represents a phenylene moiety; and
a second polymeric material (B) having a repeat unit of formula

—(F₂C—CF₂)— II
and further comprising a pigment; and
wherein said composition has a melt viscosity of at least 0.50 kNsm⁻².

The temperature in the environment may be less than −75° C., less than −100° C., less than −120° C., less than −140° C., less than −150° C. or even less than −165° C.

Said polymeric material (A) may be as described in the first aspect.

Said environment may be as described for position (A) in the further aspect. Said environment may be in or adjacent a region which contains natural gas, for example LNG; or said environment may be in a polar region.

According to a further aspect of the invention, there is provided a method of making a component for an assembly or apparatus as described in the first aspect, the method comprising:
(i) selecting a composition as described herein;
(ii) melt processing the composition;
(iii) forming said component during and/or after step (ii).

Step (ii) may comprise extrusion, injection moulding, compression moulding or spin casting.

The component, assembly, apparatus and composition may be as described in any aspect described herein.

The invention extends to a liquid natural gas (LNG) assembly which comprises a component as described in any preceding aspect, for example the first aspect.

An LNG assembly may be associated with LNG handling, transport or storage. Said assembly may be a LNG storage tank and/or a part associated therewith. Said component may be a part of an LNG storage tank and/or a part associated herewith.

Any feature of any aspect of any invention or embodiment described herein may be combined with any feature of any other invention described herein mutatis mutandis.

Specific embodiments of the invention will now be described, by way of example, with reference to the accompanying figures, in which:

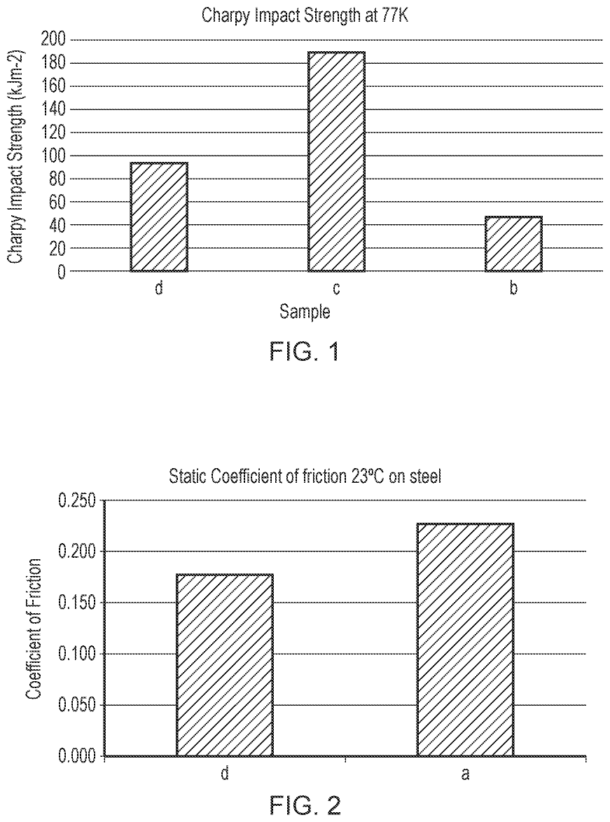

FIG. 1 shows the impact strength for samples b to d;

FIG. 2 shows the static coefficient of friction for a composition according to the invention and a comparative sample;

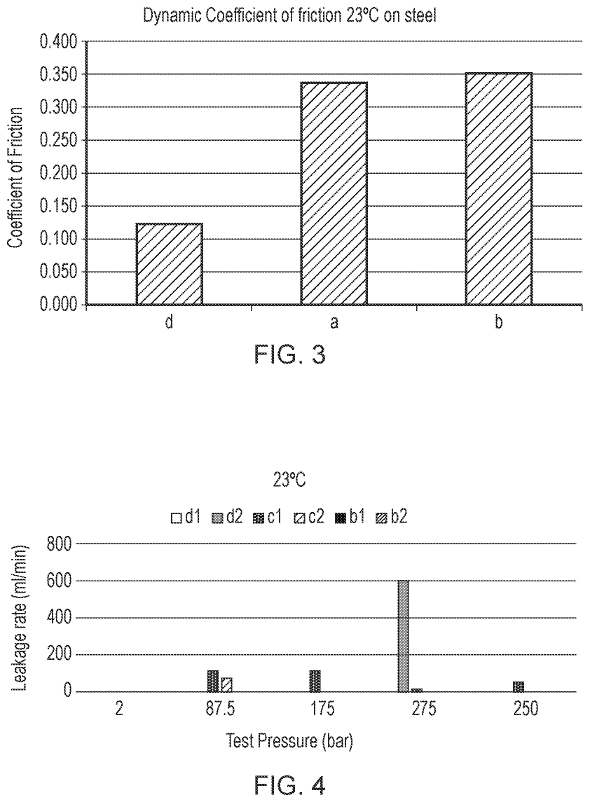

FIG. 3 shows the dynamic coefficient of friction for a composition according to the invention and a comparative sample;

FIG. 4 shows the leakage rate for a number of valve seats at 23° C. and at a range of pressures;

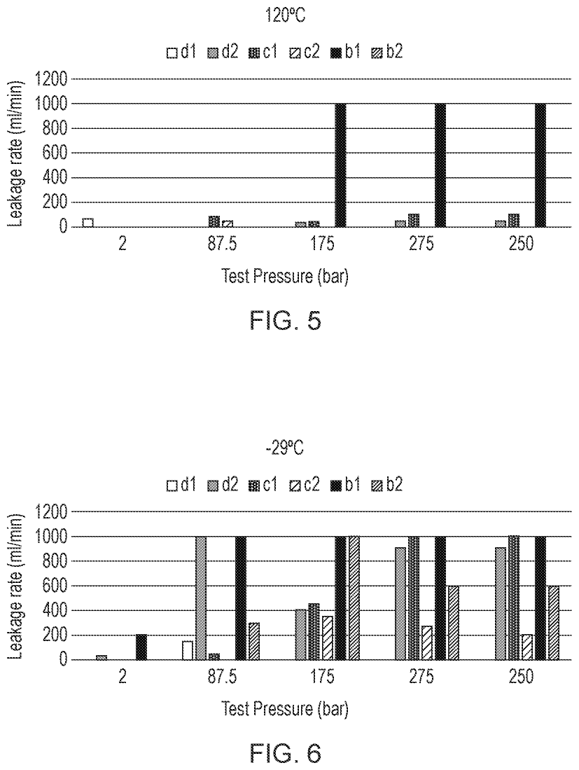

FIG. 5 shows the leakage rate for a number of valve seats at 120° C. and at a range of pressures;

FIG. 6 shows the leakage rate for a number of valve seats at −29° C. and at a range of pressures;

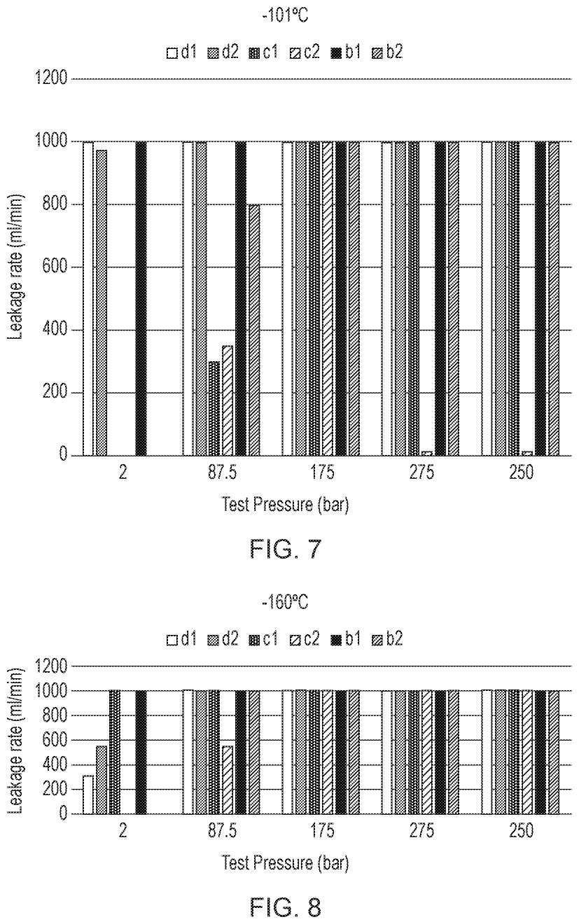

FIG. 7 shows the leakage rate for a number of valve seats at −101° C. and at a range of pressures;

FIG. 8 shows the leakage rate for a number of valve seats at −160° C. and at a range of pressures;

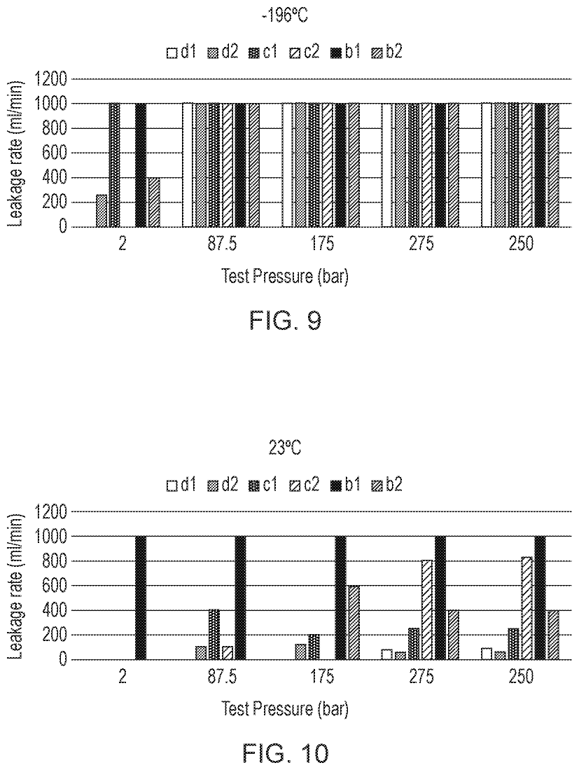

FIG. 9 shows the leakage rate for a number of valve seats at −196° C. and at a range of pressures;

and

FIG. 10 shows the leakage rate for a number of valve seats at 23° C. and at a range of pressures.

The following materials are referred to hereinafter:

PTFE—Teflon (RTM) PTFE in mechanical grade sheet form commercially available from Professional Plastics, Inc.

PCTFE—Kel-F (RTM) PCTFE in sheet form commercially available from Professional Plastics, Inc.

The following tests are used in the examples which follow.

### Test 1—Melt Viscosity of Polvaryletherketones

Melt Viscosity of polyaryletherketones was measured using a ram extruder fitted with a tungsten carbide die, 0.5 mm (capillary diameter)×3.175 mm (capillary length). Approximately 5 grams of the polyaryletherketone was dried in an air circulating oven for 3 hours at 150° C. The extruder was allowed to equilibrate to 400° C. The dried polymer was loaded into the heated barrel of the extruder, a brass tip (12 mm long×9.92±0.01 mm diameter) placed on top of the polymer followed by the piston and the screw was manually turned until the proof ring of the pressure gauge just engages the piston to help remove any trapped air. The column of polymer was allowed to heat and melt over a period of at least 5 minutes. After the preheat stage the screw was set in motion so that the melted polymer was extruded through the die to form a thin fibre at a shear rate of 1000 s⁻¹, while recording the pressure (P) required to extrude the polymer. The Melt Viscosity is given by the formula

$$Melt Viscosity = \frac{{P π r}^{4}}{8 LSA} {kNsm}^{- 2}$$

where P=Pressure/kN m⁻²
L=Length of die/m
S=ram speed/ms⁻¹
A=barrel cross-sectional area/m²
r=Die radius/m

The relationship between shear rate and the other parameters is given by the equation:

$$Apparent wall shear rate = 1000 {s}^{- 1} = \frac{4 Q}{{π r}^{3}}$$

where Q=volumetric flow rate/m³ s⁻¹=SA.

### Test 2—Melt Flow Index of Polyaryletherketones

The Melt Flow Index of the polyaryltherketone was measured on a CEAST Melt Flow Tester 6941.000. The dry polymer was placed in the barrel of the Melt Flow Tester apparatus and heated to 380° C., this temperature being selected to fully melt the polymer. The polymer was then extruded under a constant shear stress by inserting a weighted piston (5 kg) into the barrel and extruding through a tungsten carbide die, 2.095 mm bore×8.000 mm. The MFI (Melt Flow Index) is the mass of polymer (in g) extruded in 10 minutes.

### EXAMPLE 1—PREPARATION OF 4,4′-DIFLUOROBENZOPHENONE (BDF) BY REACTING FLUOROBENZENE AND 4-FLUOROBENZOYLCHLORIDE

A 10 litre 3-necked round-bottomed flask fitted with a mechanical stirrer, a thermometer, a dropping funnel containing 4-fluorobenzoyl chloride (1550 g, 9.78 moles) and a reflux condenser was charged with fluorobenzene (2048 g, 21.33 moles) and anhydrous aluminium trichloride (1460 g, 10.94 moles). The mixture was maintained at 20 to 30° C. with stirring and the 4-fluorobenzoylchloride was added dropwise over a period of 1 hour. When the addition was complete the temperature of the reaction mixture was increased to 80° C. over a period of 2 hours, allowed to cool to ambient temperature then carefully discharged into ice (4 kg)/water (2 kg). The mixture was recharged to a 20l 1-necked round-bottomed flask fitted with distil head. The contents were heated to distil off the excess fluorobenzene until a still-head temperature of 100° C. was reached. The mixture was cooled to 20° C. and the crude 4,4′-difluorobenzophenone was filtered off, washed with water and dried at 70° C. under vacuum.

The crude product was recrystallised as follows: Dry crude product (100 g) was dissolved with stirring in hot industrial methylated spirits (400 cm³) and charcoal, filtered, water (100 cm³) was added, reheated to reflux to dissolve the product and then cooled. The product was filtered off, washed with 1:1 industrial methylated spirits/water then dried at 70° C. under vacuum. The product had a melting point range of 107−108° C. and a 4,4′-difluorobenzophenone purity of greater than 99.90%. Details on the purity are provided below for three replicates of Example 1 (referred to as Examples 1a, 1b and 1c).

| | | | | | | 4,4′BDF |
|---|---|---|---|---|---|---|
| | 2,4′BDF | MFB | 4F,4′Cl | 4,4′DCBP | 4,4′ FNBP | (% w/w by |
| Example | (% w/w) | (% w/w) | (% w/w) | (% w/w) | (% w/w) | difference) |
| Example 1a | 0.005 | 0.027 | N/D | N/D | N/A | 99.97 |
| Example 1b | 0.004 | 0.026 | <0.001 | <0.001 | N/A | 99.97 |
| Example 1c | 0.003 | 0.019 | 0.002 | N/D | N/A | 99.98 |

### EXAMPLE 2—PREPARATION OF POLYETHERETHERKETONE

A 3 L vessel fitted with a ground glass Quickfit lid, stirrer/stirrer guide, nitrogen inlet and outlet was charged with 4,4′-difluorobenzophenone from Example 1 (269.76 g, 1.236 mole), hydroquinone (133.2 g, 1.2 mole) and diphenylsulphone (600 g) and purged with nitrogen for over 1 hour. The contents were then heated to between 140 and 150° C. to form an almost colourless solution. Dried sodium carbonate (127.32 g, 1.2 mole) and potassium carbonate (3.336 g, 0.0242 mole) were added. The temperature was raised to 200° C. and held for 1 hour; raised to 250° C. and held for 1 hour; raised to 315° C. and maintained for 2 hours or until the required melt viscosity was reached, as determined by the torque rise of the stirrer. The required torque rise was determined from a calibration graph of torque rise versus MV. The reaction mixture was then poured into a foil tray, allowed to cool, milled and washed with 2 litres of acetone and then with warm water at a temperature of 40-50° C. until the conductivity of the waste water was <2 μS. The resulting polymer powder was dried in an air oven for 12 hours at 120° C. The MV of the resulting polymer was 0.65 kNsm⁻² measured according to Test 1.

### EXAMPLES 3—PREPARATION OF SAMPLES OF POLYETHERETHERKETONE FROM 4,4′-DIFLUOROBENZOPHENONE (BDF) AND AT A RANGE OF MELT VISCOSITIES

The procedure described in Example 2 was repeated except the polymerisation time was varied to produce polyetheretherketone with a range of melt viscosities. The Melt Viscosity and Melt Flow Index of a range of products were assessed and a relationship between Melt Viscosity and Melt Flow Index determined.

It was found that the following relationship applied to PEEK of different melt viscosities prepared from the BDF described in Example 1:

Log₁₀ MFI=2.34−2.4×Melt Viscosity

where MFI and melt viscosity were determined as described in Tests 1 and 2.

### EXAMPLE 4—GENERAL PROCEDURE FOR PREPARING COMPOSITIONS

Formulations were prepared by compounding on a Rondol 10 mm Twin Screw Extruder operating with a die temperature of 360° C., barrel temperature of 340° C.-360° C. and with a screw speed of 84 rpm. The polymer powders were mixed and then added to the extruder via a hopper using a ‘powder’ screw feed; polymer granules were obtained at a throughput of 196 g per hour.

The size of the granules is controlled by a combination of the volumetric throughput of the extruder and the design of the die. In order to obtain very small granules which can be advantageous for compression moulding, rotational moulding and spin casting, the formulations may be formed into micropellets rather than granules. Micropellets are formed by adding a multi-orifice die or plate at the end of the extruder, wherein the die holes are much smaller in diameter than conventional die holes, and extruding the formulation through the orifices of the die. The resultant extrudate is subsequently cut either by cutting the extrudate which is in the form of strands (cold cutting) or by cutting the melt as it exits the orifices (hot or die-face cutting).

Results are provided in Table 1 below showing the formulations of the compositions according to the invention and a number of comparative examples.

TABLE 1
Compositions

| | | | | Boron | Masterbatch |
|---|---|---|---|---|---|
| Sample | PEEK | PCTFE | PTFE | nitride | pigment |
| a | 100 wt % | | | | |
| b | | 100 wt % | | | |
| c | 77 wt % | | 20 wt % | 2 wt % | Graphite 1 wt % |
| d | 73 wt % | | 20 wt % | 2 wt % | 5 wt % PEEK |
| | | | | | masterbatch green |
| | | | | | pigment equivalent |
| | | | | | to >1 wt % pigment |

Details on the tests undertaken are described below. In general, tests were undertaken at a range of temperatures from ambient temperature (23° C.) to very low temperature (77K; −196° C.) using liquid nitrogen.

### Mechanical Tests

Bending tests were carried out according to ISO 178 in liquid nitrogen. In the case of large deformations, the strains and stresses were corrected according to ISO-14125.

Tensile tests according to ISO 527 were carried out using a special test fixture (INCONEL 718) suitable for liquid nitrogen temperatures.

Charpy impact tests were performed on a Dynatup 9250HV drop tower apparatus using a drop height of 1.25 m. The Charpy impact tests were carried out on unnotched specimens in a bending configuration. The test procedure according to Standard EN ISO 179-1 was followed which specified a method for determining the Charpy impact strength of plastics.

The test specimen was supported near its ends as a horizontal beam and was impacted by a single blow of a striker, with the line of impact midway between the supports, and was bent at a high, nominally constant, velocity. During the test, the impact velocity was measured just before the impact, and then the force on the striker was recorded. The velocity and displacement of the striker was calculated to estimate the energy absorbed by the specimen. For testing at LN2 temperature each sample was immersed in a bath of liquid nitrogen for sufficient time (stop of evaporation of LN2) to allow complete cooling of the sample. After complete cooling the sample was transferred in the fixation of the drop tower and the test was performed within a time of less than 30 sec to avoid heating up of the sample.

The Charpy specimens (type 1, unnotched) had the following geometry: 80 mm×10 mm×4 mm. For calculating the Charpy impact strength of unnotched specimens, a_{cU}, expressed in kJ per square meter, the following equation was used:

a_{cU}=E_{c}/h/b. 10³, where E_{c} represents the corrected energy, in joules, absorbed by breaking the test specimen, h represents the thickness, in millimeters, of the test specimen, and b represents the width, in millimeters, of the test specimen.

The results for the impact tests are shown in FIG. 10. Sample d provides a higher impact strength than sample b but lower than sample c.

Results for tensile strength, tensile modulus, tensile elongation, flexural strength and flexural modulus for examples a to d are shown in Table 2 below. It will be noted that there were no significant differences between the samples at −196° C.

Results are provided in Table 2 below showing mechanical properties for the composition according to the invention and a number of comparative examples.

TABLE 2
Mechanical properties

| | Tensile | Tensile | Tensile | Flexural | Flexural |
|---|---|---|---|---|---|
| | modulus | strength | elongation | modulus | strength |
| Sample | (GPa) | (MPa) | (%) | (GPa) | (MPa) |
| a | 5.2 | 220 | 7.8 | 5.4 | 457 |
| b | 5.1 | 128 | 3.3 | 5.7 | 266 |
| c | 4.6 | 194 | 4.6 | 5.1 | 343 |
| d | 4.5 | 140 | 4.1 | 5.0 | 359 |

### Tribological Properties

The tests to determine the tribological properties of the compositions were carried out using a TE77 reciprocating tribometer. The reciprocating tribometer was well suited to simulating the motion of a ball valve as it moved a loaded pin back and forth across a plate material. In the experiment the plate material was the candidate valve seat material and the pin was fabricated from stainless steel with a finish equivalent to that of the ball in the ball valve. The surface finish of the polymer plates was based on typical surface finishes used in commercial ball valves after their machining processes.

Two levels of pin loading were used: 5 MPa and 50 MPa to understand the effect of using the ball valves at typical pressures and further the effects of increasing contact pressure.

Two levels of temperature were used: 23° C., simulating typical storage temperatures for valves, and 70° C., representing potential higher temperature use.

For each material and set of conditions a series of 3 tests were carried out:
Run 1a Fresh pin on fresh plate for 5 minutes
   test stopped leaving pin in contact within the track it had created (track 1)
Run 1b Pin restarted for a brief time, used pin still within track 1 (so used plate)
Run 2a The same pin was moved to fresh area on the plate, pin moved for 5 minutes creating track
test stopped leaving pin in contact within the track it had created (track 2)
Run 2b Pin restarted for a brief time, used pin still within track 2 (so used plate)
Run 3a The same pin was moved to fresh area on the plate, pin moved for 5 minutes creating track 3
   test stopped leaving pin in contact within the track it had created (track 3)
Run 3b Pin restarted for a brief time, used pin still within track 3 (so used plate)

Run 1a therefore had a unique static coefficient of friction as it was a new pin on new plate. Runs 1b, 2a, 2b, 3a and 3b all had the same static coefficient of friction as they all had a used pin on a used plate. Furthermore, runs 1a, 2a, and 3a all had the same dynamic coefficient of friction.

It has been surprisingly found that the long term tribological performance of sample d in both static and dynamic environments, displays an improvement over sample c and/or a as shown in FIGS. 2 and 3. The experiments show that while sample c and d perform similarly initially, after a number of cycles have occurred, sample d outperformed samples a and c. Both the static coefficient of friction and the dynamic coefficient of friction for sample d was found to be less than 0.2.

The effect is even more pronounced for the dynamic coefficient of friction showing that sample d is particularly suited to applications and environments which require a low coefficient of friction such as valve seats. In a ball valve, a valve seat material having a low coefficient of friction is advantageous because the coefficient of friction and the mechanical properties of the material play and important role in the operating torque of the valve.

### Leakage Properties

Leakage tests were carried out using the following Standards, Shell MESC SPE 77/300 ed.2016 (Valve Acceptance Testing) and ISO 5208 ed.2008 (Seat Leakage Allowance). Tests were carried out using a Trunnion Top-Entry Ball Valve of 10″ diameter and Class #1500. Body and Ball materials were as specified in Standard ASTM A479 316L.

Samples b, c, and d were moulded into valve seats for use with a 10″ cl. 1500 trunnion supported ball valve. A ball valve uses a ball-shaped plug with a circular hole through its centre within its valve body. The ball valve can fully open or close with a quarter turn of the ball, which is usually turned by turning a stem attached to the ball. When the valve is in the closed position it will only be effective if the fluid or gas cannot flow around it: a valve seat, on both sides of the ball ensures that there is a good seal between the ball and the valve body. The ball must necessarily always be in intimate contact with the valve seat at any point in time to ensure sealing. When the valve is activated by turning, the seal must be maintained: the seat and ball are therefore always kept in contact by a slight pressure applied through design.

The ball valve and valve seats were tested at a range of temperatures from 120° C. to −196° C. and at a range of pressures from 2 bar to 250 bar. The test was designed to replicate a ball valve is use in an LNG application. As such, the ball vale was subjected to a specific temperature cycle by starting at a temperature of 23° C. (ambient) and increasing the temperature to 120° C. before dropping the temperature to −29° C. The temperature was then dropped further to −101° C., −160° C. and −196° C. before being increased to 23° C.

FIG. 4 shows the first part of the temperature cycle at ambient temperature. The first part of the cycle showed that sample b performed better than samples c and d, but all samples tested performed well and provided adequate sealing properties. At the highest pressure, 275 bar, sample d displayed increased leakage. In the second temperature cycle at 120° C. shown in FIG. 5, sample c and d outperformed sample b displaying excellent sealing properties at the high temperature.

In the next part of the cycle temperature was dropped to −29C shown in FIG. 6, samples c and d both displayed good sealing performance whereas sample b showed a higher leakage rate. At this temperature, sample d provided improved sealing capability across all pressures tested.

Reducing the temperature further to −101° C. as shown in FIG. 7, caused all samples tested to leak shows all three products with a similar level of leakage. FIG. 8 shows that at −160° C., sampled outperformed samples c and c by a significant margin at pressures up to 175 bar but beyond that all three samples had a similar (high) leakage rate. In FIG. 8, data for the samples subjected to −196° C. shows that sample d exhibited low leakage rate at 2 bar which increased to around 1000 mm/min at higher pressure. However, this was significantly better than samples b and c which both caused leakage at a rate of around 2000 ml/min.

The results for the final cycle are shown in FIG. 10, which shows the performance of the samples once the system was returned to ambient temperature, and this showed the starkest contrast with sample d exhibiting very low rates of leakage (showing excellent recovery after the previous five cycles) while samples b and c exhibited leakage rates of around five times greater than sample d.

The data indicated that sample d had unexpectedly enhanced sealing capacity at very low temperatures.

The polymeric composition according to the invention may have wide ranging uses. For example, it may be used for parts or components which may be subjected to low temperatures in use, for example at or below cryogenic temperatures. The polymer may be used for parts or components associated with LNG storage tanks. The polymer may be used for parts or components which are to be used in polar regions, for example in or associated with oil and/or gas installations. In addition, the polymeric material is particularly useful across a broader range of thermal environments. Examples of uses of the sample d polymer include:
seals, in general e.g. valve seals, valve stem seals, butterfly valve seals, spring energised seals; seals of a seal stack, seal backup rings;
valves or parts thereof—e.g. ball valve seats, check valve seats, valve plates such as compression valve plates, valve spindles, rotary valves, valve actuators such as a solenoid valve;
gaskets;
bearings—e.g. thrust bearings;
housings—e.g. for sensors;
rings—e.g. piston, packing, throttle or wiper rings;
pipes—e.g. for aerospace or oil and gas applications or other conduits for fluid transport;
pipe liners;
connectors;
wire and cable jacketing/insulation;
bushings.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1.-5. (canceled)

6. An assembly or apparatus an assembly or apparatus suitable for use in relation to an assembly, wherein said assembly is subjected to a temperature of less than −50° C. in use, wherein said assembly or apparatus includes a component which comprises composition comprising a first polymeric material (A) having a repeat unit of formula
—O-Ph-O-Ph-CO-Ph- I
wherein Ph represents a phenylene moiety; and
a second polymeric material (B) having a repeat unit of formula
—(F₂C—CF₂)— II
and further comprising a pigment;
wherein said composition has a melt viscosity of at least 0.50 kNsm².

7. An assembly or apparatus according to claim 6, wherein said assembly or apparatus is subjected to a temperature of less than −100° C. or less than −140° C. in use, and/or wherein said component is subjected to a temperature of less than −100° C. or less than −140° C.

8. An assembly or apparatus according to claim 6, wherein said assembly is positioned in an environment wherein the temperature is at less than −100° C. or less than −150° C.

9. An assembly or apparatus according to claim 6, wherein said assembly is in a polar region or wherein said assembly is underground.

10. (canceled)

11. An assembly or apparatus according to claim 6, wherein said assembly is associated with liquid natural gas (LNG), for example LNG handling or transport, or wherein said assembly is a LNG storage tank or a part associated therewith.

12. (canceled)

13. An assembly or apparatus according to claim 6, wherein said component is a part of the storage tank or a part associated therewith.

14. An assembly or apparatus according to claim 6, wherein said component is selected from the group comprising a seal, a valve, a part of a valve, a gasket, a bearing, a part of a bearing, a housing, a ring, a pipe, a part of a pipe, a pipe liner, a connector, insulation, for example for wire or cable, and a bush.

15. An assembly or apparatus according to claim 6, wherein at least 95%, preferably at least 99%, of the number of phenylene moieties in polymeric material (A) have 1,4-linkages to moieties to which they are bonded; and the phenylene moieties in repeat unit of formula I are unsubstituted.

16. An assembly or apparatus according to claim 6, wherein said polymeric material (A) includes at least 68 mol % of repeat units of formula I.

17. An assembly or apparatus according to claim 6, wherein said repeat unit of formula I has the structure 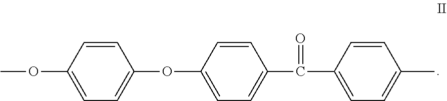
and said polymeric material (A) includes at least 80 mol %, preferably at least 99 mol % of repeat units of formula II.

18. An assembly or apparatus according to claim 6, wherein said polymeric material (A) has a MV of at least 0.60 kNsm².

19. An assembly or apparatus according to claim 6, wherein said polymeric material (A) has a MV in the range 0.55 to 0.75 kNsm².

20. An assembly or apparatus according to claim 6, wherein said component includes at least 95 wt % of said polymeric material (A).

21. A method of providing a component in a position (A) in which it is subjected to a temperature of less than −50° C., said method comprising:
(i) selecting a component, an assembly comprising said component or an apparatus comprising said component, wherein said component comprises a composition comprising a first polymeric material (A) having a repeat unit of formula
—O-Ph-O-Ph-CO-Ph- I
wherein Ph represents a phenylene moiety; and
a second polymeric material (B) having a repeat unit of formula
—(F₂C—CF₂)— II
and further comprising a pigment;
wherein said composition has a melt viscosity of at least 0.50 kNsm²; and
(ii) moving said component, assembly or apparatus to position (A).

22. (canceled)

23. A method of making a component for an assembly or apparatus as described in claim 6, the method comprising:
(i) selecting a composition as described herein;
(ii) melt processing the composition;
(iii) forming said component during and/or after step (ii);
wherein step (ii) optionally comprises extrusion or injection moulding.

24. A liquid natural gas (LNG) assembly which comprises a component as described in claim 6.

25. An assembly according to claim 6, said assembly being associated with LNG handling, transport or storage, and/or wherein said assembly is a LNG storage tank and/or a part associated therewith.

26. A polymeric micropellet, comprising a composition comprising a first polymeric material (A) having a repeat unit of formula
—O-Ph-O-Ph-CO-Ph- I
wherein Ph represents a phenylene moiety; and
a second polymeric material (B) having a repeat unit of formula
—(F2C-CF2)- II
and further comprising a pigment;
wherein said composition has a melt viscosity of at least 0.50 kNsm-2; and
wherein a longest dimension of the micropellet is 4 mm or less, more preferably less than 2 mm, and even more preferably, from 0.5 mm to 1 mm.

27. A pack comprising a polymeric micropellet according to claim 26.

28. (canceled)
